(19) United States
(12) Patent Application Publication
(10) Pub. No.: US 2010/0049858 A1
(43) Pub. Date: Feb. 25, 2010

(54) INITIAL ACCESS METHOD FOR BROADBAND WIRELESS ACCESS SYSTEM

(75) Inventors: Chul Park, Daejeon (KR); Sung-Cheol Chang, Daejeon (KR); Chul-Sik Yoon, Seoul (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/518,177

(22) PCT Filed: Dec. 5, 2007
(86) PCT No.: PCT/KR07/06287

§ 371 Date: Jun. 8, 2009

(30) Foreign Application Priority Data
Dec. 8, 2006 (KR) 10-2006-0125149

(51) Int. Cl. G06F 15/16

(52) U.S. Cl. 709/228

(57) ABSTRACT

Provided is an initial access method for a broadband wireless access system. The initial access method is used between a portable subscriber station (PSS) and a radio access station (RAS) in the broadband wireless access system and includes an authentication operation and a default transport connection setting operation. In the initial access method, default information, which is required to register the PSS and to set default transport connection, is stored in an authentication authorization accounting (AAA) server, the default information is then transmitted to the RAS connected to the PSS in the authentication operation by the AAA server, and when the PSS is registered and the default transport connection is set, a message composed of parameters, which are required to register the PSS containing the default information and to set the default transport connection, is then transmitted to the PSS by the RAS. Accordingly, a simplified initial access procedure is achieved.

### TECHNICAL FIELD

The present invention relates to a broadband wireless access system, and more particularly, to a method of simplifying an initial access procedure between a portable subscriber station (PSS) and a radio access station (RAS) in a broadband wireless access system.

This work was supported by the IT R&D program of MIC/IITA [2006-P10-03, WiBro Evolution Standardization Research].

### BACKGROUND ART

FIG. 1 illustrates a network architecture of a conventional broadband wireless access system.

The broadband wireless access system is in compliance with the institute of electrical and electronics engineers (IEEE) 802.16-2004 and IEEE 802.16e-2005 standards. For compatibility with a conventional public Internet protocol (IP) network 100, the broadband wireless system includes a portable subscriber station (PSS) 120, a radio access station (RAS) 130, and an access control router (ACR) 140. A technique is used to allow the PSS 120 to have mobility so that an IP-based network service is available while on the move.

Referring to FIG. 1, the RAS 130 is connected to an operator's IP network 110. Therefore, in order for a subscriber to use the IP-based network service, the public IP network 100 has to be accessible via the RAS 130 and the operator's IP network 110. An authentication authorization accounting (AAA) server 150 exists in the operator's IP network 110. The AAA server 150 may authenticate a subscriber who attempts to access the broadband wireless access system by using the PSS 120 or may store quality of service (QoS) information.

The subscriber can communicate with other network resources through the broadband wireless access system by using the PSS 120 only when the RAS 130 is accessed after a specific initial access procedure is carried out according to a standard defined between the PSS 120 and the RAS 130.

FIG. 2 is a flowchart of an initial access method of a broadband wireless access system defined in the IEEE 802.16-2004 and IEEE 802.16e-2005 standards.

Referring to FIG. 2, messages required in an initial access procedure of the PSS 120 and the RAS 130 include RNG-REQ/RSP 200, SBC-REQ/RSP 210, REG-REQ/RSP 230, and DSA-REQ/RSP/ACK 240 as well as messages in association with an authentication operation 220 and messages in association with a DHCP (or MIP) operation 250 for setting an IP address of the PSS 120. Content and usage of these messages used in the initial access procedure are defined in the IEEE 802.16-2004 and IEEE 802.16e-2005 standards, and thus detailed descriptions thereof will be omitted.

Referring to FIG. 2, initial access is completed between the PSS 120 and the RAS 130 when various messages are transmitted/received between the PSS 120 and the RAS 130 or between the AAA server 150 and other relevant servers existing in the operator's IP network 110. That is, the messages in association with the authentication operation 220 and the DHCP (or MIP) operation 250 are transmitted/received among the PSS 120, the RAS 130, and the AAA server 150 through a wired network. The rest of messages are transmitted/received between the PSS 120 and the RAS 130 through a wireless network.

After the authentication operation 220 is performed, the PSS 120 is registered, and default transport connection is set to allocate an IP address between the PSS 120 and the RAS 130. When the message of REG-REQ/RSP 230 are transmitted/received between the PSS 120 and the RAS 130 in order to register the PSS 120, the messages of DSA-REQ/RSP/ACK 240 are sequentially transmitted/received between the PSS 120 and the RAS 130 so that the default transport connection is set therebetween. In the default transport connection setting operation, since interactive communication is possible when an uplink connection from the PSS 120 to the RAS 130 and a downlink connection from the RAS 130 to the PSS 120 are both achieved, the messages of DSA-REQ/RSP/ACK 240 are transmitted/received only one time for the respective uplink and downlink connections so that the default transport connection is set for the uplink and downlink connections.

### DISCLOSURE OF INVENTION

### Technical Problem

The present invention provides a method for speeding up an access and minimizing a waste of wireless communication resources by simplifying an initial access procedure between a portable subscriber station (PSS) and a radio access station (RAS) in a broadband wireless access system.

Technical Solution

According to an aspect of the present invention, there is provided an initial access method of a PSS (portable subscriber station) in a wireless access system, comprising: receiving default information, which is required to register the PSS and to set default transport connection, from an AAA (authentication authorization accounting) server by a RAS(radio access station); and transmitting to the PSS by the RAS a message composed of the default information and parameters needed for a default transport connection operation.

According to an aspect of the present invention, there is provided an initial access method of a PSS (portable subscriber station) in a wireless access system, comprising: storing default information, which is required to register the PSS and to set default transport connection, in an AAA (authentication authorization accounting) server; transmitting the default information to a RAS(radio access station) connected to the PSS by the AAA server.

According to an aspect of the present invention, there is provided a wireless access system, comprising: an AAA (authentication authorization accounting) server storing default information, which is required to register a PSS(portable subscriber station) and to set default transport connection; and a RAS(radio access station) transmitting to the PSS a message composed of the default information and parameters needed for a default transport connection operation.

### Advantageous Effects

According to the present invention, the number of messages, which are transmitted/received between a PSS and an RAS, are reduced in comparison with the convention initial access method. Therefore, an initial access procedure is simplified so that the PSS can further rapidly access the RAS.

In addition, since the initial access procedure is simplified, wireless communication resources used between the PSS and the RAS are less frequently accessed, thereby enabling effective use of the wireless communication resources.

In addition, by using an AAA server included in the architecture of the conventional broadband wireless access system, the initial access procedure can be simplified without altering the architecture of the conventional system. Furthermore, the initial access procedure can be simpler than the conventional initial access procedure irrespective of an additional wired network connection.

### DESCRIPTION OF DRAWINGS

FIG. 1 illustrates a network architecture of a conventional broadband wireless access system;

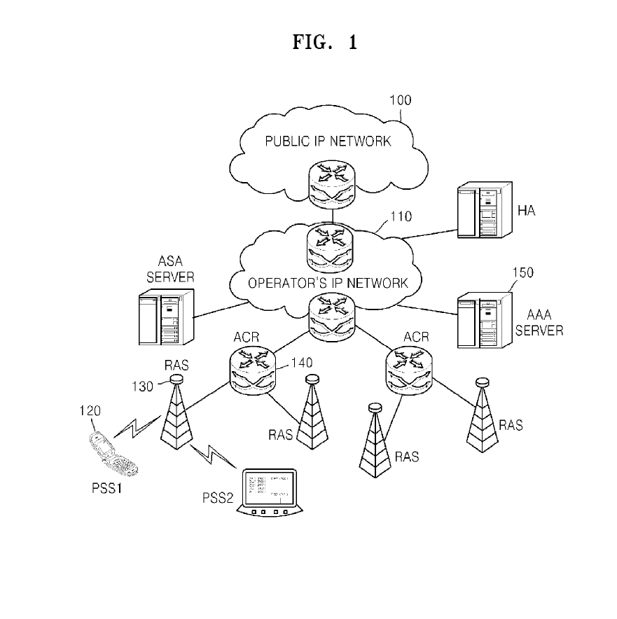

FIG. 2 is a flowchart of an initial access method of a conventional broadband wireless access system; and

FIG. 3 is a flowchart of an initial access method of a broadband wireless access system according to an embodiment of the present invention.

### BEST MODE

According to an aspect of the present invention, there is provided an initial access method of a PSS (portable subscriber station) in a wireless access system, comprising: receiving default information, which is required to register the PSS and to set default transport connection, from an AAA (authentication authorization accounting) server by a RAS(radio access station); and transmitting to the PSS by the RAS a message composed of the default information and parameters needed for a default transport connection operation.

According to an aspect of the present invention, there is provided an initial access method of a PSS (portable subscriber station) in a wireless access system, comprising: storing default information, which is required to register the PSS and to set default transport connection, in an AAA (authentication authorization accounting) server; transmitting the default information to a RAS(radio access station) connected to the PSS by the AAA server.

According to an aspect of the present invention, there is provided a wireless access system, comprising: an AAA (authentication authorization accounting) server storing default information, which is required to register a PSS(portable subscriber station) and to set default transport connection; and a RAS(radio access station) transmitting to the PSS a message composed of the default information and parameters needed for a default transport connection operation.

### Mode for Invention

Hereinafter, exemplary embodiments of the present invention will be described in detail with reference to the accompanying drawings.

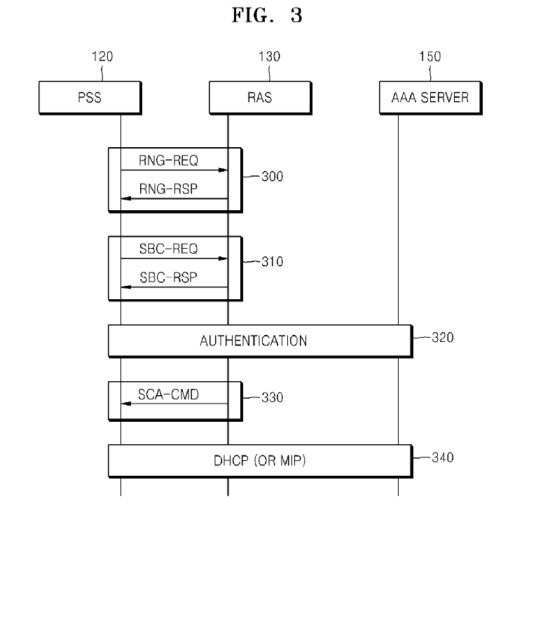

FIG. 3 is a flowchart of an initial access method of a broadband wireless access system according to an embodiment of the present invention.

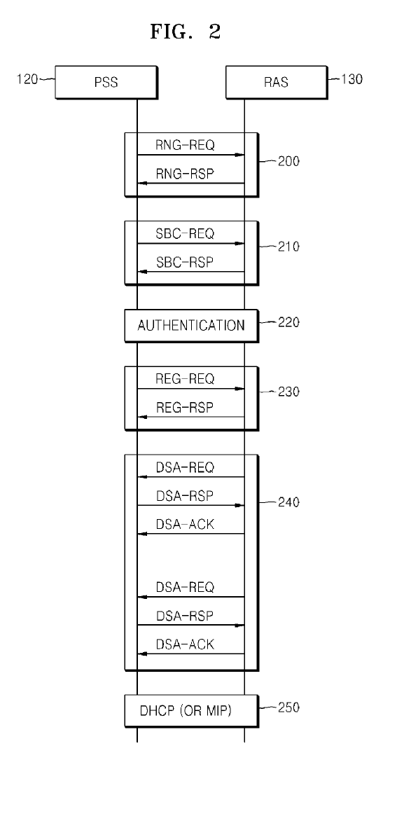

Referring to FIG. 3, according to the initial access method of the present invention, the number of messages is reduced where the messages are transmitted/received between a portable subscriber station (PSS) 120 and a radio access station (RAS) 130 and are used to register the PSS 120 and to set default transport connection after the conventional authentication operation 220 of FIG. 2 is performed. That is, in the conventional method of FIG. 2, the messages of REG-REQ/RSP 230 have to be transmitted/received between the PSS 120 and the RAS 130 after the authentication operation 220 is performed, and the message of DSA-REQ/RSP/ACK 240 each have to be transmitted/received one time so that the default transport connection can be set for both the uplink and downlink connections. However, according to the present invention of FIG. 3, only one message, that is, a static context association CoMnanD (SCA-CMD) 330, is required.

Therefore, in addition to the existing functions of an authentication authorization accounting (AAA) server 150 in the operator's Internet protocol (IP) network, that is, the function of authenticating a subscriber and a function of storing QoS information, the present invention further provides a function of pre-storing information on PSS registration and default transport connection setting, which are required when the PSS 120 accesses the RAS 130.

Additional information stored in the AAA server 150 is limited to information required to register a specific PSS or to set default transport connection with respect to a RAS. Preferably, information can be updated only in an offline manner under the control of an operator. Such information on the specific PSS that can be updated only in an offline manner will be referred to as static context. The information required to register the specific PSS or to set the default transport connection may be defined based on a certain part of content of REG-REQ/RSP messages and DSA-REQ/RSP/ACK messages which are defined in the IEEE 802.16-2004 and IEEE 802.16e-2005 standards.

The information stored in the AAA server 150 so as to register the specific PSS and to set the default transport connection is delivered from the AAA server 150 to the RAS 130 when an authentication operation 320 is ended. That is, according to a conventionally predetermined operation, several messages are transmitted/received among the PSS 120, the RAS 130, and the AAA server 150. Therefore, when such messages are last transmitted/received, the RAS 130 fetches information, which is required to register the specific PSS and to set the default transport connection, from the messages transmitted from the AAA server 150.

The RAS 130 appends information contained in the RAS 130 to the information fetched from the AAA server 150 and then configures the SCA-CMD 330 that is composed of parameters required for default transport connection, thereby transmitting the SCA-CMD 330 to the PSS 120.

The rest of messages 330, 310, 320, and 340 are processed in the same manner as described in the conventional method of FIG. 2.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. An initial access method of a PSS (portable subscriber station) in a wireless access system, comprising:
receiving default information, which is required to register the PSS and to set default transport connection, from an AAA (authentication authorization accounting) server by a RAS(radio access station); and
transmitting to the PSS by the RAS a message composed of the default information and parameters needed for a default transport connection operation.

2. The initial access method of claim 1, wherein the receiving of the default information comprises, in the last process of an authentication operation, receiving from the AAA server a message including the default information.

3. An initial access method of a PSS (portable subscriber station) in a wireless access system, comprising:
storing default information, which is required to register the PSS and to set default transport connection, in an AAA (authentication authorization accounting) server;
transmitting the default information to a RAS(radio access station) connected to the PSS by the AAA server.

4. The initial access method of claim 3, wherein the transmitting of the default information to the RAS comprises, in the last process of the authentication operation, transmitting to the RAS a message, which is transmitted from the AAA server to the RAS, by appending the default information thereto.

5. The initial access method of claim 3, wherein the AAA server exists in an operator's Internet protocol (IP) network connected to the RAS.

6. The initial access method of claim 3, wherein the default information is manually stored in the AAA server by an operator of the IP network where the AAA server exists.

7. A wireless access system, comprising:
an AAA (authentication authorization accounting) server storing default information, which is required to register a PSS(portable subscriber station) and to set default transport connection; and
a RAS(radio access station) transmitting to the PSS a message composed of the default information and parameters needed for a default transport connection operation.
